(19) United States
(12) Patent Application Publication
(10) Pub. No.: US 2021/0039241 A1
(43) Pub. Date: Feb. 11, 2021

(54) HAND-HELD MACHINE TOOL, MACHINE TOOL ASSEMBLY AND ADAPTER BUSHING

(71) Applicant: Roehm GmbH, Sontheim/Brenz (DE)

(72) Inventors: Hans BAUMANN, Sontheim-Brenz (DE); Peter SCHENK, Niederstotzingen (DE); Stefan KEMPTER, Landensberg (DE)

(73) Assignee: Roehm GmbH, Sontheim/Brenz (DE)

(21) Appl. No.: 16/985,878

(22) Filed: Aug. 5, 2020

(30) Foreign Application Priority Data
Aug. 5, 2019 (DE) 10 2019 121 049.6

(51) Int. Cl. B25F 3/00; B25F 5/02

(52) U.S. Cl. CPC B25F 3/00; B25F 5/02

(57) ABSTRACT

A hand-held machine tool having a machine spindle rotatably mounted in a machine housing, in which a control member and at least one locking member are mounted so as to be radially adjustable and are adjustable between a change position and a locking position by means of an adjusting sleeve guided on the machine spindle in such a way that, when adjusting the adjusting sleeve to the change position, the control member is acted upon radially inward by the adjusting sleeve and the locking member is not acted upon by the adjusting sleeve, that when adjusting the adjusting sleeve to the locking position, the locking member is acted upon by the adjusting sleeve, and that an adjusting ring mounted on the machine housing for adjusting the adjusting sleeve is provided between the change position and the locking position.

This nonprovisional application claims priority under 35 U.S.C. § 119(a) to German Patent Application No. 10 2019 121 049.6, which was filed in Germany on Aug. 5, 2019, and which is herein incorporated by reference

### BACKGROUND OF THE INVENTION

### Field of the Invention

The present invention relates to a hand-held machine tool having a machine spindle rotatably mounted in a machine housing, to which a control member and at least one locking member are mounted so as to be radially adjustable and are adjustable between a change position and a locking position by an adjusting sleeve guided on the machine spindle, such that when the adjusting sleeve is moved to the change position, the control member is acted upon radially inward by the adjusting sleeve and the locking member is not acted upon by the adjusting sleeve, that the locking member is acted upon by the adjusting sleeve when adjusting the adjusting sleeve to the locking position, and that an adjusting ring for adjusting the adjusting sleeve mounted on the machine housing is provided between the change position and the locking position. The invention further relates to an assembly for a machine tool and to an adapter bushing.

### Description of the Background Art

Quick-change devices are known from the prior art, for example, for drilling machines by means of which the drill chuck mounted on the drill chuck can be replaced by another drill chuck or another tool; in this regard, reference can be made to DE 44 10 519 A1.

A disadvantage of the known quick-change systems is that the assignment of the changeover mechanism to the tool that is to be interchanged results in high costs, since the changeover mechanism must be designed in multiple ways.

### SUMMARY OF THE INVENTION

It is therefore an object of the present invention to simplify the interchange of tools in hand-held machine tools.

The cooperation of a control member and a locking member simplify handling of the inventive machine tool, since the control member can force the proper alignment of the tool to be mounted on the machine tool, i.e. the control member is locked in the change position while the locking member can evade due to the lack of impingement by the adjusting sleeve. This facilitates the mounting of the tool, wherein after assembly and the change to the locking position, the locking member can perform its function by means of the impingement of the adjusting sleeve. The adjusting sleeve itself is designed such that it switches both the control member and the locking member in the desired manner when adjusting between the change position and the locking position, providing ease of use requiring no further active operation by the user, despite the use of a component in addition to the locking member, because the twisting of the adjusting ring alone is sufficient to call up the desired functions.

It is particularly preferred here that the machine spindle terminates with a hollow spindle, because this creates the possibility that the tool, which cooperates with the machine spindle and thus the machine tool, is not only fastened to the outside of the machine spindle, but also that a portion of the tool is introduced into the hollow spindle. In a machine tool equipped with a percussion mechanism it may also be possible to immerse in said hollow spindle. It is hereby expedient that the control member and the locking member are arranged at a mutual axial distance in a through hole of the machine spindle, and that the adjusting sleeve has a pocket on the inner peripheral surface and, axially adjacent to the pocket on both sides, has a contact surface on each of the two sides.

The radial adjustment of control member and locking member is thus directed inward, wherein the mutual axial distance makes it possible to position the adjusting sleeve between the control member and the locking member, and that by adjusting the adjusting sleeve, either one of the contact surfaces or the pocket are caused to respectively cooperate with the control member or the locking member. It is further provided that the adjusting sleeve is biased with a spring acting in the direction of the locking position so as to ensure permanent locking, in which the locking member is held in the through hole in the locking position by the contact surface of the adjusting sleeve.

The locking member can be provided in plurality in an arrangement distributed around the circumference of the machine spindle, and that the pocket is designed as a groove formed in the circumferential direction. This way, it is possible to even better secure the tool with respect to the machine spindle, wherein the multiple locking members provided are suited not only for axially securing the tool that is to be coupled with the machine tool, but also for improved torque transmission, i.e., it is not necessary to create additional structures for transmission of torque.

It is also expedient when the control member is designed as a control ball and the locking member as a locking ball, wherein the spherical shape ensures that the desired orientation is always provided. The locking ball and the control ball can thereby have the same diameter and be basically identically constructed. There is also the possibility of designing the control ball with a different diameter or from a different material, since the control ball is only effective in the change position with respect to the tool to be attached and does not itself have to transmit any forces.

For ergonomically improved, i.e. simplified, handling, it is provided that the adjusting ring be rotatably mounted between two catch positions associated with the change position of the locking position in the machine housing and have a control cam on the inside for the adjustment of the adjusting sleeve. Furthermore, the design is such that the control cam is assigned a spring wire which has no contact with the adjusting sleeve in the locking position. This is advantageous to the extent that during operation of the machine tool, the adjusting sleeve rotates because of its arrangement on the machine spindle.

The embodiment is also made in such a way that the axial front end of the machine housing is formed by a toothing plate that is non-rotatably connected to the machine housing and has a toothing extending in a circumferential direction. This toothing constitutes the axial cover of the machine housing and thus protects the spring wire and the adjusting sleeve against soiling. Since the toothing plate is non-rotatably connected to the machine housing, there is also the possibility of using the toothing with a positive connection to fix a tool to be mounted on the machine tool relative to the machine housing.

Thus, the toothing plate covers the spring wire and the adjusting ring and is supplemented by a locking ring arranged on the machine spindle. This offers improved protection against soiling, because due to the distance between the toothing plate and the machine spindle, the play resulting therefrom can be taken into account.

The machine spindle can be designed in two parts with the terminal part of the machine spindle being combined into a retrofittable assembly with the control member, the locking member, the adjusting sleeve and the adjusting ring, providing a separately realizable and usable good. This opens up the possibility of equipping an existing machine tool with the assembly and thus creating the possibility of attaching a quick-change mechanism to the machine tool. It then becomes possible that the terminal part of the machine spindle has a spindle holder with a female thread, because this way, the retrofittable assembly can be fixed on the machine spindle associated with the machine housing in the usual manner, comparable to a chuck body with a spindle holder. Optionally, as long as the machine-side machine spindle is configured for it, a screw for locking can also be used in a screw attachment.

The assembly can have a clamping sleeve for cooperating with the machine housing so as to simplify mounting the assembly on the machine tool.

An adapter bushing can be provided, which provides a separately realizable and useable good, having a sleeve that can be inserted in the hollow spindle, comprising the axially extending groove for cooperation with the control member and a number of spherical indentations corresponding to the number of locking members for cooperating with the locking members. The adapter bushing can thus be fixedly attached to a tool, wherein the axially extending groove allows for the effect of the control member to develop, and the formed spherical indentations cause the axial locking and rotational entrainment of the adapter bushing with respect to the machine spindle. In particular, at the end axially opposite the sleeve, the adapter bushing comprises a threaded portion for screwing into the threaded receptacle of a tool body or is designed in one piece with the tool body of a tool. This adapter bushing also makes it possible to retrofit the tool for use with the quick-change mechanism, thus creating a combination of the machine tool, the adapter bushing and the tool. Of course it is also possible that the adapter bushing is already integrated in the tool, i.e. the adapter bushing is integrally designed with the tool body, if the tool is already being serially used with the quick-change mechanism.

The tool can be, for example, a drill chuck, an angle attachment, a bit holder, a square mount, a collet chuck. In addition, there is also the possibility for the tool to have a toothing, which is complementary to the toothing plate on the side facing the machine tool, for fixing the position relative to the machine housing. This is particularly advantageous when using an angle attachment or other attachments which have to be positively connected to the stationary part of the machine, since this way the attachment is radially fixed to the machine housing.

The assembly with the terminal part of the machine spindle, including the control member, the locking member, the adjusting sleeve and the adjusting ring as well as the adapter bushing comprising the sleeve insertable in the hollow spindle, which sleeve has an axially extending groove for cooperation with the control member and a number of spherical indentations corresponding to the number of locking members for the cooperation with the locking members and has a threaded portion for screwing into the threaded receptacle on the side axially opposite the sleeve, are technically independently realizable components which allow for the retrofitting of machine tools and tools for use in the advantageous quick-change system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a machine tool with an integrated assembly and a set of interchangeable tools,

FIG. 2 shows a representation corresponding to FIG. 1, including the drill chuck mounted in the assembly using the adapter bushing,

FIG. 3 is a perspective illustration of a drill chuck with an attached adapter bushing,

FIG. 4 is a side view partially shown in a section of a drill chuck mounted on the machine spindle of the machine tool, shown in the change position,

FIG. 5 shows a representation corresponding to FIG. 4, shown in the locking position,

FIG. 6 shows a longitudinal section through a perspective view of an assembly formed as a retrofitted part,

FIG. 7 shows a representation corresponding to FIG. 1, with the assembly prior to attachment to the machine spindle,

FIG. 8 shows a representation corresponding to FIG. 7, with the assembly attached to the machine spindle, and

FIG. 9 is a side view of an angle attachment, shown partly in section.

### DETAILED DESCRIPTION

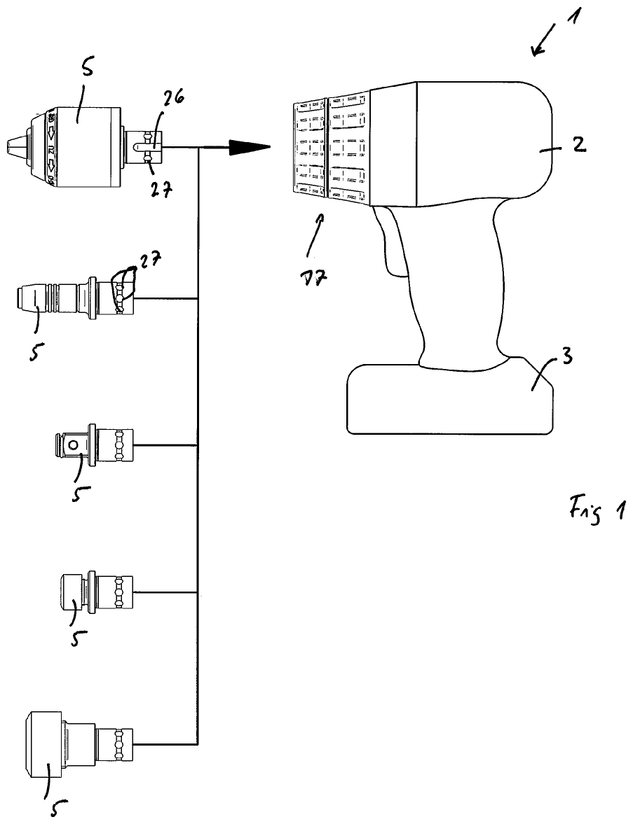

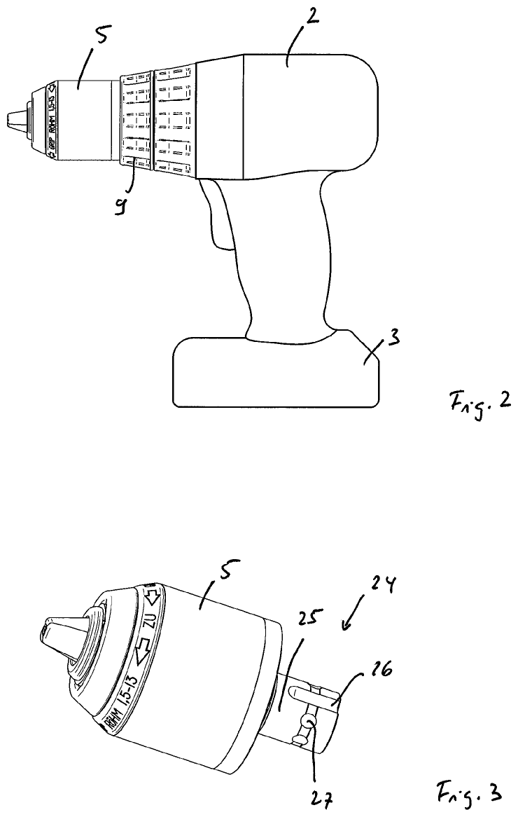

FIG. 1 shows a hand-held machine tool in a wireless embodiment, wherein energy is supplied by means of an accumulator 3 associated with the machine housing 2 of the machine tool 1; a wired machine tool 1 can also be used with the invention. In the machine housing 2 of the machine tool 1, a machine spindle 4 is rotatably mounted, which can be used for the rotating drive of a tool 5 or used as a tool. In FIG. 1, various tools 5 are shown which can be used with a hand-held machine tool 1, so that a change of the tools 5 is also useful in being able to reduce the number of hand-held machine tools 1 that need to be provided.

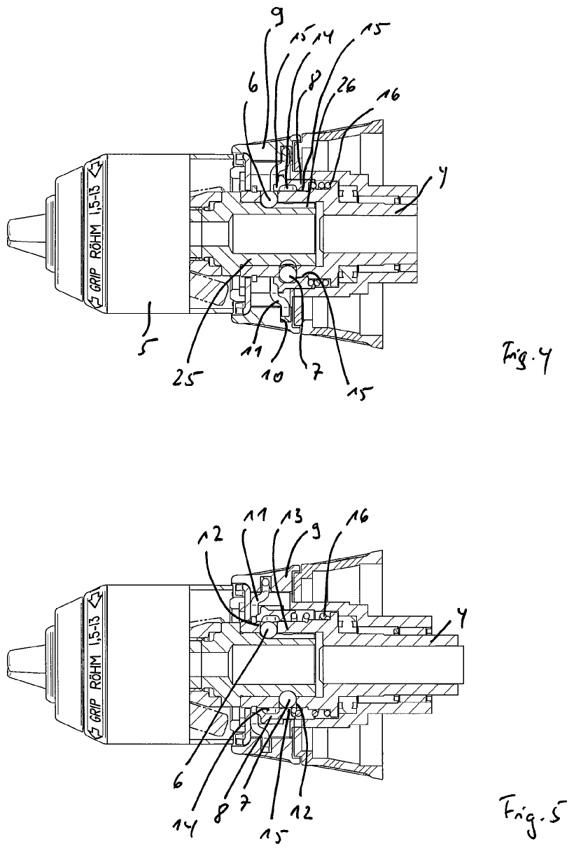

In order to execute a quick-release mechanism, a control member 6 and at least one locking member 7 are mounted in the machine spindle 4 so as to be radially adjustable, which can be adjusted between a change position and a locking position by an adjusting sleeve 8 guided on the machine spindle 4. The adjustment option is thereby such that when adjusting the adjusting sleeve 8 to the change position, the control member 6 is radially inwardly acted upon by the adjusting sleeve 8 and the locking member 7 is not acted upon by the adjusting sleeve 8. These configurations in the change position are shown in FIG. 4, wherein FIG. 4 also reveals that an adjusting ring 9 mounted on the machine housing 2 for the adjustment of the adjusting sleeve 8 is provided between the change position and the locking position. The adjusting ring 9 itself is rotatably mounted on the machine housing between two catch positions, with one of the catch positions being dedicated to the change position and the other catch position being dedicated to the locking position. On its inside, the adjusting ring 9 has a control cam 10 for adjusting the adjusting sleeve 8, wherein in the exemplary embodiment shown, a spring wire 11 which has no contact with the adjusting sleeve 8 in the locking position is assigned to the control cam 10.

FIG. 4 also shows that the control member 6 and the locking member 7 are arranged at a mutual axial distance in through holes 12 of the machine spindle 4, which is at least terminally designed as a hollow spindle 13. The adjusting sleeve 8 has a pocket 14 on the inner circumferential surface and, axially adjacent to the pocket 14, has a contact surface 15 on each of the two sides. In the change position according to FIG. 4, the locking member 7 is received in the pocket 14, whereas the one contact surface 15 presses the control member 6 radially inward.

In contrast, FIG. 5 shows the locking position, in which by the rotation of the adjusting ring 9 from one catch position to the other catch position, the adjusting sleeve 8 is moved in the axial direction of the machine spindle 4 so that the locking member 7 is moved radially inward by a contact surface 15 of the adjusting sleeve 8, whereas now, the pocket 14 of the adjusting sleeve 8 is situated opposite the control member 6. The adjusting sleeve 8 is biased by a spring 16 acting in the direction of the locking position, thus securing the position of the adjusting sleeve 8. This way, there are two safety mechanisms, on the one hand the catch position of the adjusting ring 9 and on the other hand, the spring 16 acting in the direction of the locking position. The control member 6 is designed as a control ball and the locking member 7 is designed as a locking ball.

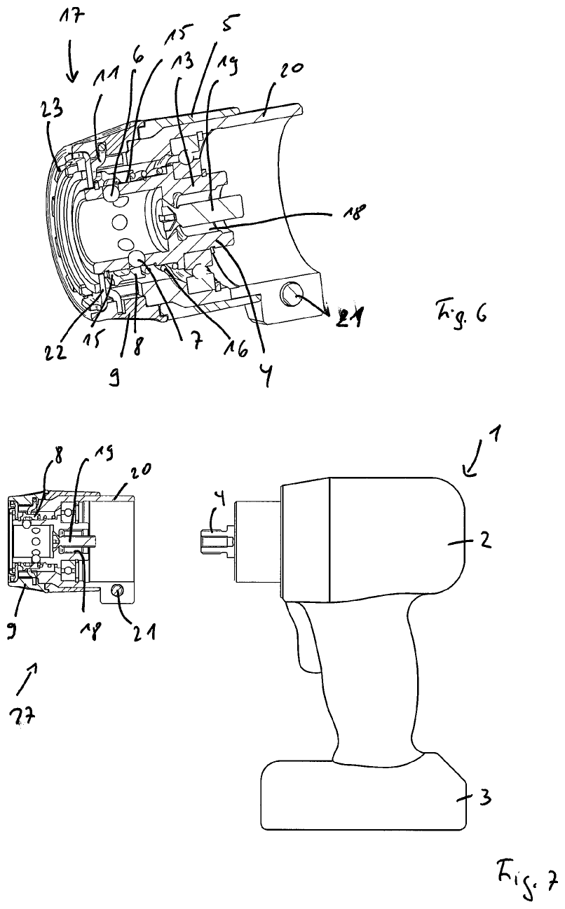

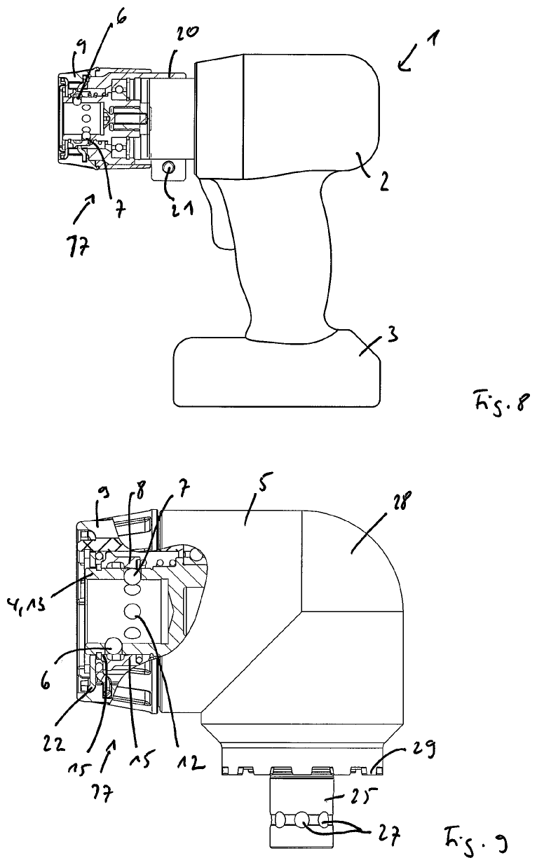

FIG. 6 shows the possibility of a retrofittable assembly 17 being provided with the terminal part of the machine spindle 4, including the control member 6, the locking member 7, the adjusting sleeve 8 and the adjusting ring 9, wherein the representation in FIG. 6 shows that the locking member 6 is provided multiple times, arranged distributed around the circumference of the machine spindle 4, which then requires the pocket 14 to be expanded as a groove extending in the peripheral direction.

FIG. 6 also shows that the terminal part of the machine spindle 4 as part of the assembly 17 comprises a spindle mount 18 having an internal thread, so that typically instead of a tool body of a tool 5, the assembly 17 can be screwed to the machine spindle 4 and, as long as the machine spindle 4 is designed appropriately, can be additionally secured by locking a screw 19. The assembly 17 itself has a clamping sleeve 20 for cooperating with the machine housing 2, which is actuated by a locking screw 21.

The axial front end of the machine housing 2, or accordingly, of the assembly 17, is formed by a toothing plate 22 which is rotationally fixed to the machine housing 2, which is formed with a toothing 23 extending in the circumferential direction.

The above-described components are provided to cooperate with an adapter bushing 24 having a sleeve 25 that can be inserted in the hollow spindle 13, which sleeve comprises a radially extending groove 26 for the cooperation with the control member 6 and a number of spherical indentations 27 corresponding to a number of locking members 7 for cooperation with the locking members 7. This adapter bushing 24 may be integrally formed with the tool body of a tool 5 or comprise a threaded portion at the end that is axially opposite the sleeve 25 for screwing into the threaded receptacle of a tool body.

FIG. 9 shows a tool 5 that can be coupled to the machine tool 1, namely an angle attachment 28 which has a toothing 29 on the side facing the machine tool 1 that is complementary to the toothing plate 22, for fixing the position relative to the machine housing 2. It should be noted that the angle attachment 28 can be connected with the machine tool 1 via the adapter bushing 24 associated therewith, whereas at its other end the angle attachment 28 has a structure, which is comparable to the machine tool 1 in the manner of the previously described assembly 17, for enabling the connection with another tool 5, for example a drill chuck.

Below, the handling of the machine tool 1 will now be briefly described when changing a tool 5. The basis is the configuration shown in FIG. 4, showing the change position in which the adjusting ring 9 is rotated into the catch position, in which the control cam 10 acts via the spring wire 11 on the adjusting sleeve 8 in such a way that the adjusting sleeve 8 is moved axially rearward to the machine housing 2 of the machine tool 1 by biasing the spring 16 which acts on the adjusting sleeve 8. The position of the adjusting sleeve 8 can cause the locking member 7 or the locking members 7 to evade the spherical indentations 27 of the sleeve 25, whereas the control member 6 is adjusted radially inward in the hollow spindle 13. In this configuration, the drill chuck shown in FIG. 4 can be removed from the hollow spindle 13 to the left. The machine tool 1 is still in the change position, so that a different tool, or the same tool 5, can be inserted again in the hollow spindle 13 from the left, wherein the control member 6 forces the correct alignment of the sleeve 25 in cooperation with the groove 26 of the sleeve 25, so that the locking members 7 enter correctly into the spherical indentations 27 and ensure the axial securing of the sleeve 25 with respect to the machine spindle 4 and at the same time offer the possibility of torque transmission.

After changing from the change position to the locking position by the rotation of the adjusting ring 9 from one catch position to the other catch position, the configuration according to FIG. 5 is obtained. This indicates that the adjusting sleeve 8 is biased by the spring 16, assumes the locking position required for the position, with the impingement of the locking members 7 by the contact surface 15 of the adjusting sleeve 8, whereas the control member 6 is received in the pocket 14.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A hand-held machine tool comprising:
a machine spindle rotatably mounted in a machine housing;
a control member; and
at least one locking member, the control member and the at least one locking member being mounted in the machine housing so as to be radially adjustable and adjustable between a change position and a locking position via an adjusting sleeve guided on the machine spindle such that when adjusting the adjusting sleeve to the change position, the control member is acted upon radially inward by the adjusting sleeve and the locking member is not acted upon by the adjusting sleeve and such that when adjusting the adjusting sleeve to the locking position, the locking member is acted upon by the adjusting sleeve; and
an adjusting ring attached on the machine housing to adjust the adjusting sleeve between the change position and the locking position.

2. The machine tool according to claim 1, wherein the machine spindle is terminally designed as a hollow spindle.

3. The machine tool according to claim 1, wherein the control member and the locking member are arranged at a mutual axial distance in through holes of the machine spindle, and wherein the adjusting sleeve has a pocket on an inner peripheral surface and, axially adjacent to the pocket, has a contact surface on each of two sides.

4. The machine tool according to claim 1, wherein the adjusting sleeve is biased by a spring acting in a direction of the locking position.

5. The machine tool according to claim 3, wherein the locking member is provided multiple times, arranged distributed around the circumference of the machine spindle, and wherein the pocket is designed as a groove formed in the circumferential direction.

6. The machine tool according to claim 1, wherein the control member is a control ball and the locking member is a locking ball.

7. The machine tool according to claim 1, wherein the adjusting ring is rotatably mounted on the machine housing between two catch positions which are assigned to the change position and the locking position and has a control cam on an inside for adjusting the adjusting sleeve.

8. The machine tool according to claim 7, wherein the control cam is assigned a spring wire which has no contact with the adjusting sleeve in the locking position.

9. The machine tool according to claim 1, wherein the axial front end of the machine housing is formed by a toothing plate having a toothing extending in the circumferential direction, which is non-rotatably connected to the machine housing.

10. The machine tool according to claim 9, wherein the toothing plate covers the spring wire and the adjusting ring and is supplemented by a securing ring arranged on the machine spindle.

11. The machine tool according to claim 1, wherein the machine spindle is formed in two parts, with the terminal part of the machine spindle comprising the control member, the locking member, the adjusting sleeve and the adjusting ring combined so as to form a retrofittable assembly.

12. The machine tool according to claim 11, wherein the terminal part of the machine spindle has a spindle holder with an internal thread.

13. The machine tool according to claim 12, wherein the assembly has a clamping sleeve for cooperation with the machine housing.

14. The machine tool according to claim 2, wherein an adapter bushing is provided with a sleeve which is insertable into the hollow spindle, wherein the sleeve has an axially extending groove for cooperation with the control member and a plurality of spherical indentations corresponding to the plurality of locking members for cooperation with the locking members.

15. The machine tool according to claim 14, wherein the adapter bushing on an end axially opposite the sleeve has a threaded portion for screwing in a threaded receptacle of a tool body or is integrally formed with the tool body of a tool.

16. The machine tool according to claim 15, wherein the machine tool is a drill chuck, an angle attachment, a bit holder, a square mount, or a collet chuck.

17. The machine tool according to claim 16, wherein on a side facing the machine tool, the tool has a toothing which is complementary to the toothing plate for fixing the position relative to the machine housing.
